(19) United States
(12) Patent Application Publication
(10) Pub. No.: US 2022/0365526 A1
(43) Pub. Date: Nov. 17, 2022

(54) MACHINE LEARNING SYSTEM AND MACHINE LEARNING MODEL MANAGEMENT METHOD USING MACHINE LEARNING SYSTEM

(71) Applicant: Hitachi, Ltd., Tokyo (JP)

(72) Inventors: Sayuri ISHIKAWA, Tokyo (JP); Soichi TAKASHIGE, Tokyo (JP); Masafumi TSUYUKI, Tokyo (JP); Daisuke KOMAKI, Tokyo (JP)

(73) Assignee: Hitachi, Ltd., Tokyo (JP)

(21) Appl. No.: 17/691,784

(22) Filed: Mar. 10, 2022

(30) Foreign Application Priority Data
May 14, 2021 (JP) 2021-082783

(51) Int. Cl. G05B 23/02

(52) U.S. Cl. CPC G05B 23/0283; G05B 23/0221

(57) ABSTRACT

When an event such as maintenance occurs, a model in which a tendency of input data changes due to an influence of the maintenance and retraining is required is specified. Model identifiers that specify the machine learning models and are unique to the machine learning models and sensor identifiers that specify the sensors that output the sensor data serving as the input data of the machine learning models and are unique to the sensors are managed to be in association with each other. A degree of influence indicating a change in tendency of the sensor data before and after the maintenance operation is performed is obtained for each maintenance event identifier that specifies a maintenance operation performed on a device and is unique to the maintenance operation, and the degree of influence is managed in association with each of the sensor identifiers. When the sensor whose degree of influence satisfies a predetermined condition is influenced by the maintenance operation, the model identifier associated with the sensor identifier of the sensor satisfying the condition is presented.

### BACKGROUND OF THE INVENTION

### 1. Field of the Invention

The present invention relates to a machine learning system and a machine learning model management method using the machine learning system.

### 2. Description of the Related Art

The invention relates to a machine learning system that is mounted with machine learning models created using machine learning or the like, and executes inference by the machine learning or the like, and a machine learning model management method using the machine learning system (hereinafter, the machine learning model is also referred to as a model).

There is a machine learning system in which an operation status of a factory or the like is monitored by a sensor, and a machine learning model created by using, as an input, the sensor data is used to detect an abnormality such as a failure. However, the machine learning system as a subject in the invention is not only used for detecting the abnormality, but also can be, for example, a system that executes inference by being mounted with the machine learning model, for example, finding a target image using the machine learning model.

In such a machine learning system, there is a usage form in which a plurality of machine learning models are mounted on one machine learning system and inference or diagnosis is executed.

However, due to aged deterioration of equipment in the factory or the like, sensor data with which the models have been trained and sensor data to be a new input may deviate from each other, and the models may not appropriately detect the abnormality. Therefore, there is a case where the sensor data with which the models are trained is updated regularly to deal with the deteriorating equipment. However, when planned maintenance or the like is performed and a tendency of data is changed, there is a possibility that some of the machine learning models cannot appropriately detect the abnormality.

In WO 2019/150565 (Patent Literature 1), a machine learning model and training data input by the machine learning model are managed in association with each other. Information indicating that there is a new trained model generated using the training data is posted.

In the related art, the machine learning model is specified, and retraining of the specified machine learning model is performed. However, in the case of maintenance, since various types of data are deviated for each maintenance type, it is not possible to specify which machine learning model influences the maintenance, and it is not possible to specify the machine learning model influenced by the maintenance. Even if the machine learning model can be specified, retraining of the model cannot be performed until data whose tendency after maintenance has changed is accumulated, and during this time, the model cannot appropriately detect the abnormality.

The invention has been made in view of the above problems, and an object of the invention is to provide a machine learning system capable of specifying a model in which, when an event such as maintenance occurs, a tendency of input data is changed due to an influence of the maintenance and retraining is required, and a machine learning model management method using the machine learning system.

### SUMMARY OF THE INVENTION

In order to solve the above problems, a machine learning system according to one aspect of the invention includes: one or more machine learning models to which a machine learning algorithm is applied; and a processor. The machine learning system is configured to use, as input data, sensor data output by one or more sensors that detect a state of a device that is an abnormality detection target to detect an abnormality of the device based on the input data. The processor manages model identifiers that specify the machine learning models and are unique to the machine learning models and sensor identifiers that specify the sensors that output the sensor data serving as the input data of the machine learning models and are unique to the sensors in association with each other, obtains, for each maintenance event identifier that specifies a maintenance operation performed on the device and is unique to the maintenance operation, a degree of influence indicating a change in tendency of the sensor data before and after the maintenance operation is performed, and manages the degree of influence in association with each sensor identifier, and when the sensor whose degree of influence satisfies a predetermined condition is influenced by the maintenance operation, presents the model identifier associated with the sensor identifier of the sensor satisfying the condition.

According to the invention, it is possible to provide the machine learning system capable of specifying the model in which, when an event such as maintenance occurs, the tendency of input data is changed due to the influence of the maintenance and retraining is required, and the machine learning model management method using the machine learning system.

### BRIEF DESCRIPTION OF THE DRAWINGS

FIG. 1 is a diagram illustrating an outline of an operation of a machine learning system according to an embodiment;

FIG. 2 is a diagram illustrating a schematic configuration of the machine learning system according to the embodiment;

FIG. 3 is a diagram illustrating an example of a model-sensor association table of a machine learning system according to a first embodiment;

FIG. 4 is a diagram illustrating an example of an event-sensor association table of the machine learning system according to the first embodiment;

FIG. 5 is a flowchart illustrating an example of an operation of the machine learning system according to the first embodiment;

FIG. 6 is a diagram illustrating an example of update candidate model information according to the first embodiment;

FIG. 7 is a diagram illustrating an example of an event-sensor association table of a machine learning system according to a second embodiment;

FIG. 8 is a diagram illustrating an example of the event-sensor association table of the machine learning system according to the second embodiment;

FIG. 9 is a flowchart illustrating an example of an operation of the machine learning system according to the second embodiment;

FIG. 10 is a flowchart illustrating an example of an operation of a machine learning system according to a third embodiment; and

FIG. 11 is a diagram illustrating an example of a screen displayed on a display unit of the machine learning system according to the embodiment.

### DESCRIPTION OF THE PREFERRED EMBODIMENTS

Hereinafter, embodiments of the invention will be described with reference to the drawings. The embodiments described below do not limit the invention according to the claims, and all the elements and combinations thereof described in the embodiments are not necessarily essential to the solution of the invention.

In all the drawings for showing the embodiments, units having the same function are denoted by the same reference numerals, and repetitive descriptions thereof are omitted.

Further, in the following description, an expression “xxx data” may be used as an example of information, but a data structure of the information may be any data structure. That is, “xxx data” can be referred to as a “xxx table” to show that the information does not depend on the data structure. Further, “xxx data” may be simply referred to as “xxx”. In the following description, a configuration of each type of information is an example, and the information may be divided and held, or may be combined and held.

In the following description, there is a case where a process is described using a “program” as a subject, and since the program is executed by a processor (for example, a central processing unit (CPU)) to perform a determined process appropriately using a memory resource (for example, a memory) and/or a communication interface device (for example, a port), the subject of the process may be the program. The process described using the program as the subject may be a process performed by the processor or a computer including the processor.

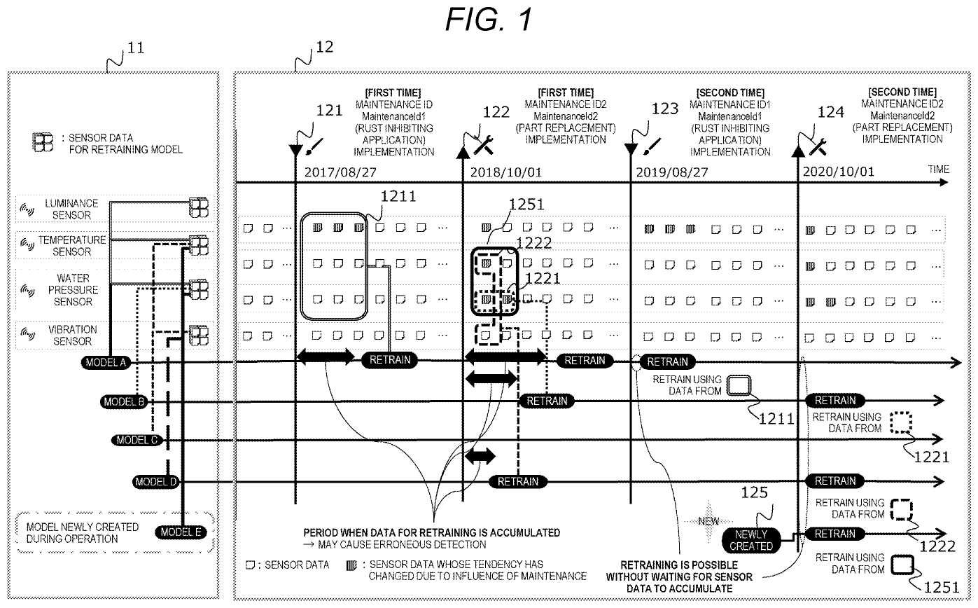

FIG. 1 is a diagram illustrating an outline of an operation of a machine learning system according to an embodiment. The outline of the embodiment will be described with reference to this drawing, and then the details will be described with reference to the subsequent drawings.

Reference numeral 11 in the drawing denotes association between models and sensor data with which the models are to be trained. A model A is trained using inputs from a luminance sensor, a temperature sensor, and a water pressure sensor. A model B is trained using the input from the water pressure sensor. A model C is trained using inputs from the temperature sensor and a vibration sensor. A model D is train using the input from the vibration sensor. A model E is trained using inputs from the temperature sensor and the water pressure sensor.

Reference numeral 12 in the drawing denotes association of sensor data influenced by maintenance events (maintenance operation) based on the sensor data. As indicated by reference numeral 121, when maintenance, i.e., rust inhibiting application specified by a maintenance ID: MaintenanceId1 is performed, the luminance sensor is influenced by the maintenance event and a tendency of the sensor data is changed. Thereafter, when luminance sensor data whose tendency has been changed by the event specified by the maintenance ID: MaintenanceId1 is accumulated for a certain period or longer, the model A, which is a model that has been trained by receiving the luminance sensor data, receives sensor data shown in a range indicated by reference numeral 1211 in the drawing, and is retrained. At this time, a type of the sensor data used for retraining and a period thereof are recorded. However, the model A may cause erroneous detection until the retraining is completed.

As indicated by reference numeral 122 in the drawing, when maintenance, i.e., part replacement specified by a maintenance ID: MaintenanceId2 is performed, the luminance sensor, the temperature sensor, and the water pressure sensor are influenced by the maintenance event and the tendency of the sensor data is changed. Thereafter, when each sensor data whose tendency has been changed by the event specified by the maintenance ID: MaintenanceId2 is accumulated for a certain period or longer, the model B and the model D, which are models that have been trained by receiving these sensor data, are retrained. Specifically, the model B revives sensor data or the like in a range indicated by reference numeral 1221 in the drawing and is trained. The model D receives sensor data or the like in a range indicated by reference numeral 1222 in the drawing and is trained. At this time, a type of the sensor data used for retraining and a period thereof are recorded. However, the model B and the model D may cause erroneous detection until the retraining is completed.

As indicated by reference numeral 123 in the drawing, a case where the maintenance, i.e., the rust inhibiting application specified by the maintenance ID: MaintenanceId1 is performed again will be described. Also at this time, the luminance sensor is influenced by the maintenance event and the tendency of the sensor data is changed. The maintenance event specified by the maintenance ID: maintenanceldl is performed in reference numeral 121 as described above and the type of the sensor data used for retraining of the model and the period thereof are recorded at that time. Therefore, when the maintenance event specified by the maintenance ID: MaintenanceId1 is performed for the first time, the model A is retrained using the sensor data for retraining that is indicated by reference numeral 1211 in the drawing. At this time, since the model A can be retrained without waiting for accumulation of the sensor data after a certain period has elapsed, there is a possibility that a period during which the model causes erroneous detection can be shortened.

As indicated by reference numeral 124 in the drawing, a case where the maintenance, i.e., the part replacement specified by the maintenance ID: MaintenanceId2 is performed again will be described. Also at this time, the luminance sensor, the temperature sensor, and the water pressure sensor are influenced by the maintenance event and the tendency of the sensor data is changed. The maintenance event specified by the maintenance ID: MaintenanceId2 is performed in reference numeral 122 as described above and the type of the sensor data used for retraining of the model and the period thereof are recorded at that time. Therefore, when the maintenance event specified by the maintenance ID: MaintenanceId2 is performed for the first time, the model B is retrained using the sensor data for retraining that is indicated by reference numeral 1221 in the drawing. When the maintenance event specified by the maintenance ID: MaintenanceId2 is performed for the first time, the model D is retrained using the sensor data for retraining that is indicated by reference numeral 1222 in the drawing. At this time, since the model B and the model D can be retrained without waiting for accumulation of the sensor data after a certain period has elapsed, there is a possibility that a period during which the models cause erroneous detection can be shortened.

A model indicated by reference numeral 125 in the drawing is a model newly created during the operation. As described above, the model E uses the inputs from the temperature sensor and the water pressure sensor. This is different from any one of the inputs from the model A, the model B, the model C, and the model E. After the model E is created, when the maintenance, i.e., the part replacement specified by the maintenance ID: MaintenanceId2 indicated by reference numeral 124 in the drawing is performed, this maintenance corresponds to the first maintenance for the model E. However, since the maintenance specified by the maintenance ID: MaintenanceId2 has been performed in the past, and retraining using the water pressure sensor as an input, which is an input to the model E, has been performed, the model E is retrained using sensor data in a range indicated by reference numeral 1251 in the drawing. The sensor data that can be used for retraining of the model E is data after the maintenance, i.e., the part replacement specified by the maintenance ID: MaintenanceId2 in the past has been performed.

### First Embodiment

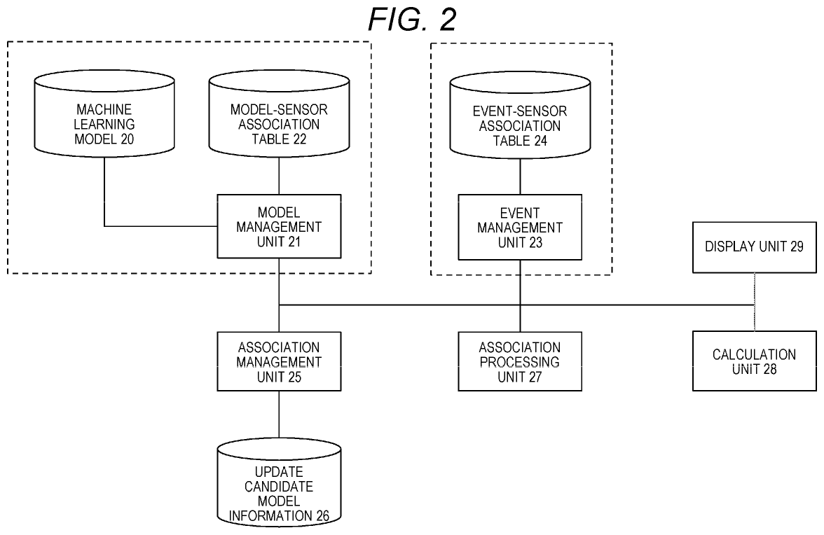

FIG. 2 is a diagram illustrating an outline of a system configuration of a machine learning system according to a first embodiment.

The machine learning system according to the present embodiment illustrated in FIG. 2 includes machine learning models 20, a model management unit 21, a model-sensor association table 22, an event management unit 23, an event-sensor association table 24, an association management unit 25, update candidate model information 26, an association processing unit 27, a calculation unit 28, and a display unit 29.

The machine learning system according to the present embodiment is an apparatus capable of performing various types of information processing, for example, an information processing apparatus such as a computer. The machine learning system includes a processor represented by a CPU and a memory, and further includes a storage and an input device.

The processor is, for example, a central processing unit (CPU), a graphics processing unit (GPU), or a field-programmable gate array (FPGA). The memory and the storage include, for example, a magnetic storage medium such as a hard disk drive (HDD), and a semiconductor storage medium such as a random access memory (RAM), a read only memory (ROM), and a solid state drive (SSD). A combination of an optical disk such as a digital versatile disk (DVD) and an optical disk drive is also used as the memory and the storage. In addition, a known storage medium such as a magnetic tape medium is also used as the memory and the storage.

A program such as firmware is stored in the storage. When an operation of the machine learning system is started (for example, when power is turned on), the program such as firmware is read from the storage and executed in the memory, and the entire control of the machine learning system is performed. In addition to the program, the memory stores data or the like required for each process of the machine learning system.

The machine learning system according to the present embodiment may be configured by a so-called cloud in which a plurality of information processing apparatuses are configured to be able to communicate with each other via a communication network.

The machine learning models 20 use, as input data, sensor data output from various sensors such as a luminance sensor (not shown) in FIG. 2, and is trained according to a known machine learning algorithm based on the input data. As described in detail in FIG. 1, the machine learning system according to the present embodiment includes a plurality of machine learning models 20, and preferably, the sensor data which is the input data of each machine learning model 20 may be different. Here, different sensor data means that, when one or more pieces of input data of the machine learning models 20 exist, these input data are different from each other.

The model management unit 21 manages the model-sensor association table 22 in which association between the (machine learning) model 20 and sensor data as an input for the model 20 to be trained is described.

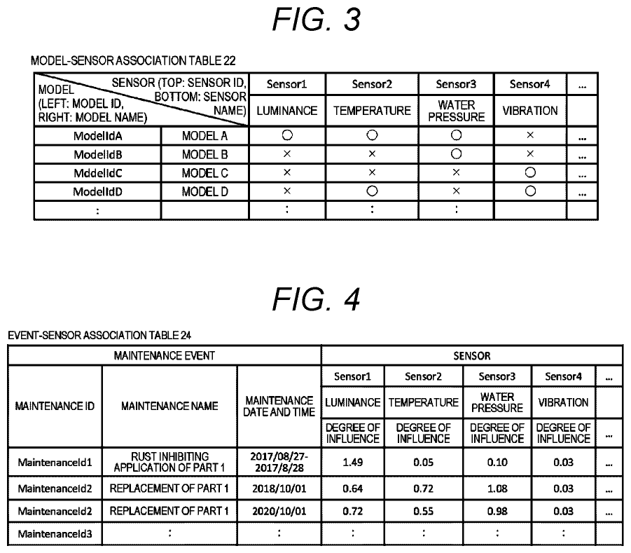

Information managed by the model management unit 21 is recorded in the model-sensor association table 22. This may be recorded as in a table of FIG. 3 described later.

The event management unit 23 manages the event-sensor association table 24 in which association between an event such as maintenance and sensor data influenced by the event is described. In the present embodiment, the event is illustrated by mentioning maintenance as an example, but the event may not be maintenance, and may be, for example, a typhoon or a snow. The event refers to an event that changes the tendency of the sensor data from a normal state.

Information managed by the event management unit 23 is recorded in the event-sensor association table 24. This may be recorded as in FIG. 4 described later.

The association management unit 25 associates the information managed by the model management unit 21 with the information managed by the event management unit 23, and, when a maintenance event occurs, specifies a model influenced by the maintenance event.

Information managed by the association management unit 25 is recorded in the update candidate model information 26. This may be recorded as in a table of FIG. 6 described later.

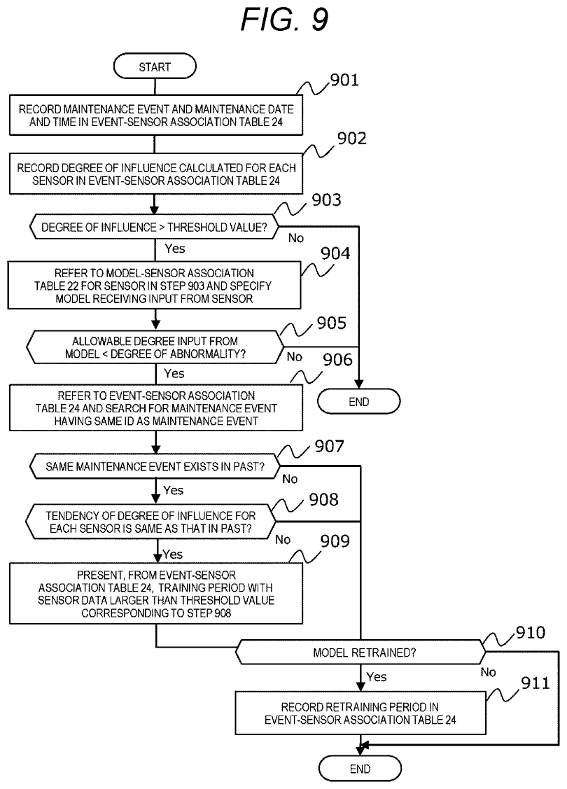

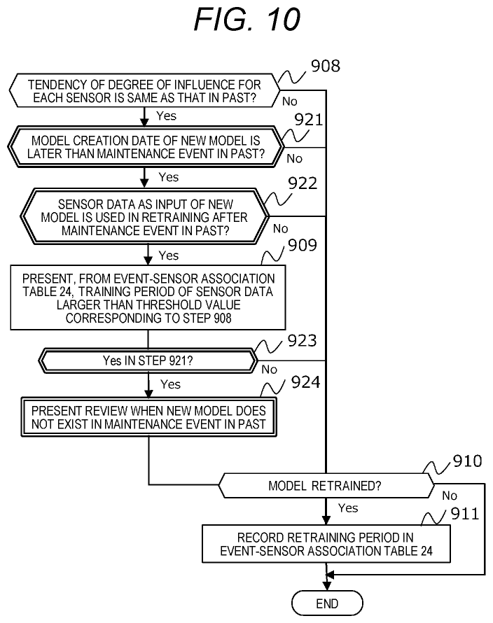

The association processing unit 27 presents a period of the sensor data used as the input from the model 20 with reference to the association between the model 20 and the sensor and the association between the event and the sensor shown in a second embodiment. The details are illustrated in FIGS. 9 and 10. The calculation unit 28 calculates the degree of influence and the like for specifying the sensor data influenced by the event.

The display unit 29 displays a predetermined screen based on a display control signal sent from the calculation unit 28. The input device transmits, based on an input instruction operation from an operator (not shown) of the machine learning system, an input instruction signal to each unit constituting the machine learning system.

In FIG. 2, the model 20 and the model-sensor association table 22 are input or prepared in advance by a data scientist or the like. The event-sensor association table 24 may be input by the operator of the machine learning system.

FIG. 3 illustrates the model-sensor association table 22 in which the association between the model 20 and the sensor data as an input for the model 20 to be trained is managed.

In the model-sensor association table 22, the association between a model identifier such as a model ID or a model name for specifying the model 20 and a sensor identifier such as a sensor ID or a sensor name that outputs the sensor data as an input for the model 20 to be trained is managed.

For example, the model A receives the inputs from the luminance sensor, the temperature sensor, and the water pressure sensor, and does not receive the input from the vibration sensor. The model B receives the input from the water pressure sensor, and does not receive the input from the luminance sensor, the temperature sensor, and the vibration sensor. In this way, the sensor identifier used as the input of training is managed for each model identifier. However, the association between the model used in the present embodiment and the sensor data for the model to be trained may not necessarily be the same as that in FIG. 3. That is, it is sufficient that the relationship between the model and the information as the input of the model is known.

FIG. 4 illustrates the event-sensor association table 24 in which the association between the event such as maintenance and the sensor data influenced by the event is managed.

In the event-sensor association table 24, the association between a maintenance identifier such as a maintenance ID or a maintenance name for specifying a maintenance event and a degree of influence on a sensor identifier such as a sensor ID or a sensor name for specifying a sensor is managed.

The calculation unit 28 records a date and time when the maintenance event in which the maintenance ID is MaintenanceID1, that is, the rust inhibiting application of a part 1 is performed, and the degree of influence on a sensor identifier in order to specify the sensor influenced by the maintenance event. The degree of influence is a value indicating a degree of change in sensor data before and after the maintenance event is performed. The degree of influence is calculated according to, for example, the following equation.

$$Degree of influence = \frac{Degree of contribution of sensor}{Difference in degree of abnormality} \qquad [ Equation 1 ]$$

In the above equation, the degree of contribution disclosed in Japanese Patent No. 4832609 is used, and the degree of abnormality disclosed in Japanese Patent No. 5480440 is used. Details are given in the reference patents, but to explain the outline, the degree of abnormality is obtained as a value obtained by obtaining a feature vector obtained by normalizing the sensor data, clustering the feature vector, setting an absolute value of the feature vector having the largest distance to a cluster center as a cluster radius r, and dividing, by the cluster radius r, a distance d to the cluster center of the feature vector of the sensor data to be calculated of the degree of abnormality. The difference in degree of abnormality is obtained as a difference in degree of abnormality before and after the maintenance event is performed. The degree of contribution indicates the degree of contribution of each sensor data constituting a plurality of sensor data used for the calculation of the degree of abnormality with respect to the calculated degree of abnormality, and is obtained as a value obtained by dividing, by the distance d described above, a representative value of the sensor data constituting the sensor data and the cluster.

As a matter of course, the degree of influence is not necessarily obtained according to the above equation. The degree of influence may be a value that shows a degree of change in sensor data before and after the event such as maintenance, or may be expressed as high, medium, or low. When the information as the input of the model is an image, a change in luminance of the image or the like corresponds to the degree of influence. That is, it is only necessary to know whether the information as the input of the model is influenced by the event.

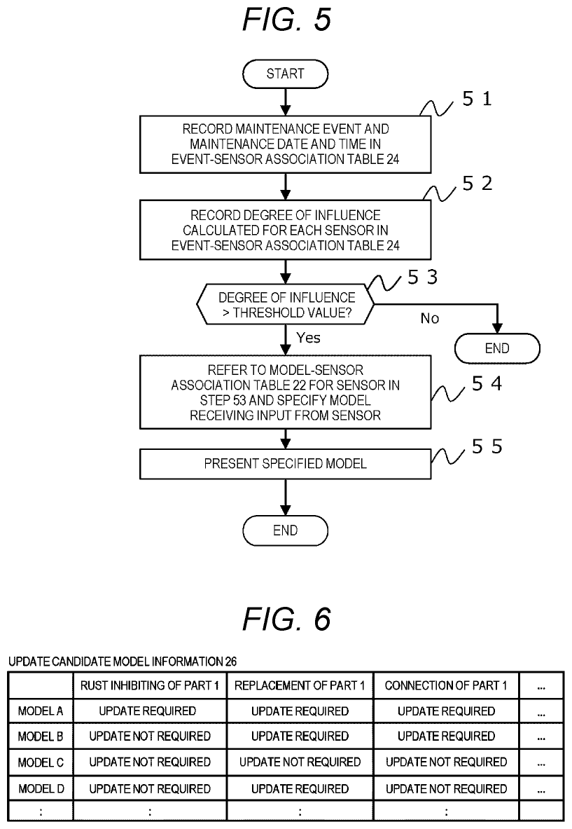

FIG. 5 is a flowchart illustrating an operation of the machine learning system according to the present embodiment, and is a flowchart illustrating a process for specifying a model to be retrained because the sensor data is changed due to the influence of the event such as a maintenance operation.

When the event such as maintenance occurs, the event management unit 23 records the maintenance event identifier such as a maintenance ID or a maintenance name and the date and time in the event-sensor association table 24 (step 51).

Next, the event management unit 23 records, in the event-sensor association table 24, the degree of influence calculated by the calculation unit 28 for each sensor identifier (step 52).

Then, when the degree of influence calculated in step 52 is higher than a preset threshold value (YES in step 53), for the sensor identifier having the degree of influence, the association management unit 25 refers to the model-sensor association table 22 and specifies a model in which the sensor identifier is included in the input (step 54). It is recommended that the threshold value be set in advance by confirming the change in sensor data that is required for retraining of the model by the data scientist or the like who creates the model, but is not limited thereto.

Then, the association management unit 25 presents the model specified in step 54 by a GUI or the like via a display unit, for example, as illustrated in FIGS. 6 and 10 to be described later (step 55).

FIG. 6 is a table in which the event identifier is associated with the model identifier that is influenced by the event and is required for retraining.

For example, in the illustrated event-sensor association table 24, when the maintenance, i.e., the rust inhibiting application of the part 1 whose maintenance ID is MaintenanceId1 is performed, the degree of influence of the luminance sensor having a sensor ID of Sensor1 is 1.49 as illustrated in FIG. 4. At this time, assuming that the threshold value is 0.5, since the degree of influence 1.49 of the luminance sensor is larger than the threshold value, it can be determined that the maintenance event specified by the maintenance ID of MaintenanceId1 influences the luminance sensor.

Therefore, the association management unit 25 refers to the model-sensor association table 22 and specifies the model 20 in which the luminance sensor is included in the input. With reference to the model-sensor association table 22, it can be seen that the model 20 in which the luminance sensor is included in the input is the model A.

Therefore, when the maintenance event, i.e., the rust inhibiting application of the part 1 is performed, the model A is highly likely to be retrained, so that the model A is “update required” and the model B, the model C, and the model D are “update not required”. This is also performed in the case of other events, for example, replacement of the part 1 or connection of the part 1, and a model that is likely to require retraining is specified for each event.

The above is a flow of a process in the machine learning system according to the first embodiment. By performing such a management and a process on information, when an event such as maintenance occurs, it is possible to specify the model 20 which is influenced by the event and is more likely to be retrained. Accordingly, the possibility that the model 20 causes erroneous detection can be reduced.

### Second Embodiment

Next, a machine learning system according to the second embodiment will be described.

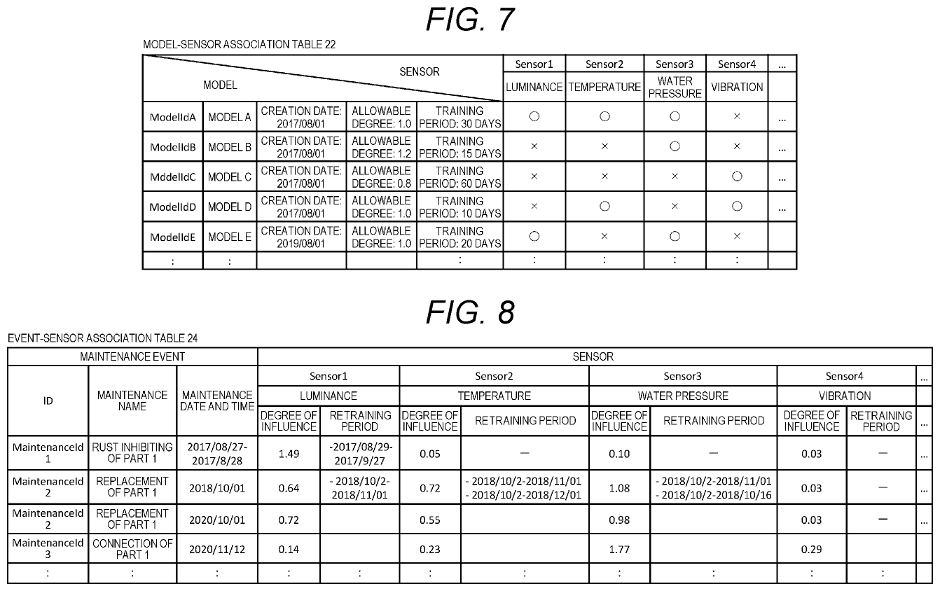

FIG. 7 is a diagram illustrating the model-sensor association table 22 according to the second embodiment in which the association between the model 20 and the sensor data as an input for the model 20 to be trained is managed, similar to the model-sensor association table 22 according to the first embodiment illustrated in FIG. 3. Therefore, the present drawing mainly describes the differences from that in FIG. 3.

The model identifier such as a model ID or a model name, a date and time when the model identifier is created, an allowable degree determined for each model 20, and an estimated period of the sensor data as an input for the model 20 to be trained are associated with each other. Further, as illustrated in FIG. 3, the association of the sensor identifier such as a sensor ID or a sensor name that outputs sensor data as an input for the model to be trained is managed.

The allowable degree determined for each model 20 is a value that serves as a guide for each model to be retrained. For example, when the degree of abnormality of the model is larger than the allowable degree of the table before and after the maintenance, it is recommended to retrain a model having the model identifier. Since the allowable degree may be different for each model, the allowable degree may be determined for each model in the table.

The estimated period of the sensor data as the input for the model 20 to be trained is a period of the sensor data used for training of the model 20. For example, the model 20 is trained, i.e., the model A is trained by receiving, as inputs, luminance sensor data for about 30 days, temperature sensor data for about 30 days, and water pressure sensor data for about 30 days. The model 20 is trained, i.e., the model B is trained by receiving, as the input, water pressure sensor data for about 15 days. By illustrating the estimated training period, it is possible to refer to the estimated training period when retraining is performed using past sensor data in process flows illustrated in FIGS. 9 and 10 to be described later.

FIG. 8 is a diagram illustrating the event-sensor association table 24 according to the second embodiment in which the association between the event such as maintenance and sensor data influenced by the event is managed, similar to the event-sensor association table 24 according to the first embodiment illustrated in FIG. 4. Therefore, the present drawing mainly describes the differences from that in FIG. 4.

For each maintenance identifier such as a maintenance ID and a maintenance name, and for each sensor identifier such as a sensor ID and a sensor name, there is a change in sensor data to be input to the model 20 before and after a maintenance event, and when the model 20 is retrained, if the sensor data is used at the time of retraining, a period of use is recorded for each sensor identifier.

For example, the maintenance event, i.e., the rust inhibiting application to the part 1, which is specified by MaintenanceId1, is performed, a tendency of the luminance sensor data is changed due to the influence of the maintenance event as in the first embodiment. Thereafter, the model A is retrained with the luminance data as an input by a method shown in the first embodiment based on the determination of the data scientist or the like.

At this time, a period used for retraining is recorded in the luminance sensor data. That is, in a column of the luminance sensor data in FIG. 8, 2017/08/29-2017/09/27 is recorded as the period used for retraining. Accordingly, it is possible to grasp that the model 20 is retrained due to the influence of the maintenance event specified by MaintenanceId1, and then the retraining is performed by using the data of the above-mentioned period of the luminance sensor data.

FIG. 9 is a flowchart illustrating a process of managing the information illustrated in FIGS. 7 and 8, in which since the sensor data is changed due to the influence of the event such as maintenance, the model 20 to be retrained is specified and the sensor data to be used for retraining is presented.

When the event such as maintenance occurs, the event management unit 23 records the maintenance event identifier such as a maintenance ID or a maintenance name and the date and time in the event-sensor association table 24 (step 901).

Next, the event management unit 23 records, in the event-sensor association table 24, the degree of influence calculated by the calculation unit 28 for each sensor identifier (step 902).

Then, when the degree of influence recorded in step 902 is higher than the preset threshold value (YES in step 903), for the sensor identifier having the degree of influence, the association management unit 25 refers to the model-sensor association table 22 and specifies a model in which the sensor identifier is included in the input (step 904). On the other hand, when the degree of influence is equal to or less than the preset threshold value (NO in step 903), the process ends.

It is recommended that the threshold value be set in advance by confirming the change in sensor data that is required for retraining of the model by the data scientist or the like who created the model, but is not limited thereto.

Next, the model management unit 21 acquires the allowable degree of the model specified in step 904, and compares the degree of abnormality output by the model with the allowable degree. When the degree of abnormality is higher than the allowable degree (YES in step 905), the association processing unit 27 refers to the event-sensor association table 24 and searches for a maintenance event similar to the maintenance event illustrated in step 901 (step 906). On the other hand, when the degree of abnormality is equal to or less than the allowable degree (NO in step 905), the process ends.

The degree of abnormality illustrated in step 905 is a degree to which the model 20 determines the input sensor data as an abnormality as a result of abnormality detection, as in the first embodiment. For the degree of abnormality, reference is made to Japanese Patent No. 5480440.

The association processing unit 27 obtains a result of step 906, and when, for example, there is a maintenance event having the same maintenance ID in the past (step 907) and an influence on each sensor managed in the event-sensor association table 24 has the tendency same as the influence in the past (step 908), the association processing unit 27 presents, from the event-sensor association table 24, a training period with the sensor data larger than the threshold value corresponding to step 908 (step 909). Here, the tendency similar to the influence in the past illustrated in step 908 may not be exactly the same numerical value as the value in the past, for example, for example, sensor data values from pre-maintenance to post-maintenance in the past are increased or decreased between about 20% to 30%, and it is sufficient that the rough tendency is the same.

Based on the determination in step 909, when retraining is performed by, for example, inputting sensor data presented by the model (step 910), the event management unit 23 records a period used for retraining with each sensor for each event ID in the event-sensor association table 24 (step 911), and ends the process. When a branch of step 907 and step 908 is No, the process proceeds to step 910, and when a branch of step 910 is No, the process ends.

### Third Embodiment

Next, a machine learning system according to a third embodiment will be described.

Similar to FIG. 9 according to the second embodiment, FIG. is a flowchart illustrating a process of managing the information illustrated in FIGS. 7 and 8, in which since the sensor data is changed due to the influence of the event such as maintenance, the model 20 to be retrained is specified and the sensor data to be used for retraining is presented.

The differences from that in FIG. 9 are the processes shown in steps 921, 922, 923, and 924 indicated by double lines. In this process, even when a new model 20 is created during the operation described in the last description of FIG. 1, it is possible to present the sensor data to be the input for the retraining of the new model 20.

Since the processes up to step 908 are the same as the processes shown in steps 901 to 907 in FIG. 9, the processes after step 908 will be described.

When the influence of each sensor has a tendency same as that of the influence in the past (Yes in step 908), a model creation date of the new model 20 is later than the maintenance event in the past (Yes in step 921), and the sensor data as the input of the new model 20 is used in the retraining after the maintenance event in the past (Yes in step 922), the association processing unit 27 presents, from the event-sensor association table 24, the training period with the sensor data larger than the threshold value corresponding to step 908 (step 909).

When the process in step 921 is Yes (step 923), since the new model 20 does not exist in the maintenance event in the past, the event management unit 23 may present a review such as retraining of the model 20 (step 924). The processes after step 910 are the same as those in FIG. 9. When the branches of step 921, step 922, and step 924 are No, the process proceeds to step 910.

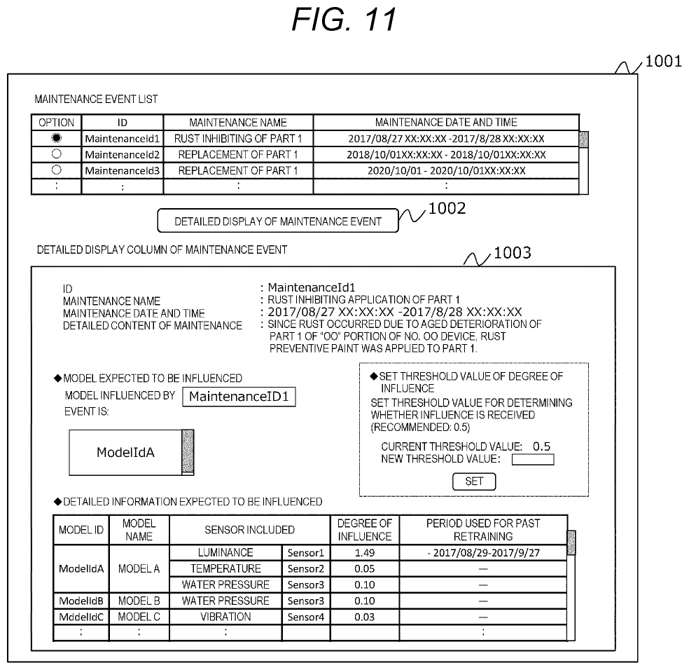

FIG. 11 is a diagram illustrating an example of a GUI 1001 in the machine learning system according to the embodiment.

In a maintenance event list, the date and time (2017/08/27 XX:XX:XX-2017/8/28 XX:XX:XX) when the maintenance is performed is displayed for the maintenance identifier such as a maintenance ID (MaintenanceId1) or a maintenance name (the rust inhibiting application of the part 1).

For example, a user selects a maintenance identifier whose details are to be confirmed, and presses a detail display button 1002 of the maintenance event. Thus, the detailed information of the maintenance identifier is displayed in a detail display column 1003 of the maintenance event.

As the displayed information, the maintenance identifier such as a maintenance ID or a maintenance name, the date and time when the maintenance is performed, and the description of the maintenance content (for example, since rust or the like occurred due to aged deterioration of the part 1 of the “00” portion of the No. 00 device, a rust preventive paint was applied to the part 1) may be written.

In the maintenance identifier, the influenced model identifier (ModelIdA) may be displayed, and as detailed information of the model identifier, a model ID, a model name (model A), a sensor identifier (Sensor1) included as an input in the model, a value of the degree of influence, a period used as input sensor data for retraining when retraining is performed with the same maintenance ID in the past, and the like may be displayed. In the GUI, for example, the threshold value may be changed, such as the degree of influence assumed to be influenced by the maintenance of the model, which is described in the present embodiment.

The embodiments described above have been described in detail for easy understanding of the invention, and the invention is not necessarily limited to those including all the configurations described above. A part of the configurations of the embodiments may be deleted and may be added and replaced with another configuration.

As an example, in the present embodiment, the retraining is performed using the sensor data at the same maintenance identifier performed in the past, and the model 20 is created. Alternatively, instead of the retraining using the past sensor data, the model 20 used in the past may be used as it is.

In the present embodiment, an example in which the retraining is performed using the past sensor data before the sensor data influenced by the maintenance is accumulated has been described. Thereafter, the model 20 may be retrained using the current sensor data after the sensor data influenced by the maintenance is accumulated.

In the present embodiment, an example in which one type of maintenance event is performed during a period has been described, but in an actual maintenance operation, there is a possibility that a plurality of types of maintenance events are simultaneously performed. For example, the maintenance event specified by MaintenanceId1 and the maintenance event specified by MaintenanceId2 are performed at the same time. In this case, if the information when the maintenance event specified by MaintenanceId1 has been performed in the past (for example, the information described in MaintenanceId1 line of the event-sensor association table 24) and the information when the maintenance event specified by MaintenanceId2 has been performed (for example, the information described in MaintenanceId2 line of the event-sensor association table 24) exist, it is possible to estimate a degree of influence when MaintenanceId1 and MaintenanceId2 are performed at the same time based on the addition of the degrees of influence of maintenance events specified by MaintenanceId1 and MaintenanceId2. Therefore, even when a plurality of types of maintenance events are performed at the same time, the model 20 influenced by the maintenance may be specified, and the sensor data used for the past retraining may be presented.

The branches of the conditions of the process flows illustrated in FIGS. 5, 9, and 10 of the present embodiment may be automated by the determination for the threshold value or the like, or may be determined by a person.

In the present embodiment, retraining may be performed using the past sensor data, and the operator may confirm whether the model that has been retrained is adopted in the system, and determine whether the model should be adopted.

In the present embodiment, a storage location of the sensor data to be input when the model 20 is retrained is not particularly limited, and the sensor data influenced by the maintenance event may be stored separately in a place where access is easy.

The method for calculating the degree of contribution, the degree of abnormality, and the allowable degree described in the present embodiment is an example.

The tables, the process flows, and the GUI illustrated in the first to third embodiments are merely examples, and do not necessarily have to have the same content, and other information may be included therein.

The configurations, functions, processing units, processing means, or the like may be implemented by hardware by designing a part or all of the above with, for example, an integrated circuit. Further, the invention can also be implemented by a program code of software that implements the functions of the embodiments. In this case, a storage medium recording the program code is provided to a computer, and a processor included in the computer reads out the program code stored in the storage medium. In this case, the program code itself read out from the storage medium implements the functions of the above-mentioned embodiments, and the program code itself and the storage medium storing the program code constitute the invention. Examples of the storage medium for supplying such a program code include a flexible disk, a CD-ROM, a DVD-ROM, a hard disk, a solid state drive (SSD), an optical disk, a magneto-optical disk, a CD-R, a magnetic tape, a nonvolatile memory card, or a ROM.

Further, for example, the program code that implements the functions described in embodiments can be implemented by a wide range of programs or script languages, such as an assembler, C/C++, perl, Shell, PHP, Java (registered trademark), and Python.

Further, all or some of the program codes of the software that implements the functions of the respective embodiments may be stored in a storage of the machine learning system in advance, or may be stored in a storage from a non-transitory storage medium of another device connected to the network or from a non-transitory storage medium via an external I/F (not shown) included in the machine learning system, as necessary.

Further, the program code of the software that implements the function of the embodiments may be stored in a storage device such as a hard disk or a memory of a computer or a storage medium such as a CD-RW or a CD-R by delivering via a network, and a processor included in the computer may read out and execute the program code stored in the storage device or the storage medium.

In the embodiments described above, control lines and information lines are considered to be necessary for description, and all control lines and information lines are not necessarily shown in the product. All configurations may be connected to each other.

What is claimed is:

1. A machine learning system configured to use, as input data, sensor data output by one or more sensors that detect a state of a device that is an abnormality detection target to detect an abnormality of the device based on the input data, the machine learning system comprising:
one or more machine learning models to which a machine learning algorithm is applied; and
a processor, wherein
the processor
manages model identifiers that specify the machine learning models and are unique to the machine learning models and sensor identifiers that specify the sensors that output the sensor data serving as the input data of the machine learning models and are unique to the sensors in association with each other,
obtains, for each maintenance event identifier that specifies a maintenance operation performed on the device and is unique to the maintenance operation, a degree of influence indicating a change in tendency of the sensor data before and after the maintenance operation is performed, and manages the degree of influence in association with each of the sensor identifiers, and
when the sensor whose degree of influence satisfies a predetermined condition is influenced by the maintenance operation, presents the model identifier associated with the sensor identifier of the sensor satisfying the condition.

2. The machine learning system according to claim 1, wherein
the processor, when the sensor whose degree of influence is larger than a predetermined threshold value is influenced by the maintenance operation, presents the model identifier associated with the sensor identifier of the sensor satisfying the condition.

3. The machine learning system according to claim 1, wherein
the degree of influence is obtained based on a change of a degree of abnormality before and after the maintenance operation is performed, the degree of abnormality being a deviation between a range of normal values of sensor data obtained as a result of clustering the sensor data and actual sensor data.

4. The machine learning system according to claim 1, wherein
the processor
manages a time at which the machine learning model is created, an allowable degree that is a determination criterion for determining whether the machine learning model is abnormal, and a training period with the sensor data input for training of the machine learning model in association with each of the model identifiers, and
when the maintenance operation is performed, manages, in association with each maintenance event identifier, a time at which the maintenance operation is performed and a set of a retraining period and the sensor identifier used for retraining when retraining of the machine learning model is performed.

5. The machine learning system according to claim 4, wherein
the processor
searches for a maintenance event having a maintenance event identifier same as the maintenance event identifier of the maintenance event associated with a degree of abnormality when the degree of abnormality is larger than the allowable degree, the degree of abnormality being a deviation between actual sensor data and a range of normal values of sensor data obtained as a result of clustering the sensor data, and the sensor data being the input data of the machine learning model associated with the allowable degree,
reads the retraining period corresponding to the same maintenance event identifier, and presents retraining of the machine learning model of the model identifier by inputting the sensor data of the sensor identifier corresponding to the retraining period when the same maintenance event identifier exists in the past and a tendency of the degree of influence for each sensor is the same as that in the same maintenance event, and
records the retraining period with the sensor data of the sensor identifier, which is an input of a retraining process of the machine learning model associated with the model identifier in accordance with the maintenance event identifier, when the same maintenance event identifier does not exist in the past, the tendency of the degree of influence of each sensor is not the same as that in the same maintenance event, and the retraining of the machine learning model is further performed.

6. The machine learning system according to claim 5, wherein
when a new machine learning model is registered in the machine learning system during an operation of the machine learning system,
the processor reads the retraining period corresponding to the same maintenance event identifier, and presents retraining of the new machine learning model by inputting the sensor data of the sensor identifier corresponding to the retraining period, when a creation date of the new machine learning model is later than the maintenance operation in the past and the sensor data which is input data of the new machine learning model is used for the retraining in the maintenance operation in the past, and when the same maintenance event identifier exists in the past and the tendency of the degree of influence for each sensor is the same as that in the same maintenance event.

7. The machine learning system according to claim 1, further comprising:
a display unit, wherein
the processor causes, when the sensor whose degree of influence satisfies the predetermined condition is influenced by the maintenance operation, the display unit to display the model identifier associated with the sensor identifier of the sensor satisfying the condition, the sensor configured to output the input data of the machine learning model associated with the model identifier, and the degree of influence associated with the sensor.

8. A machine learning model management method using a machine learning system, the machine learning system including one or more machine learning models to which a machine learning algorithm is applied and configured to use, as input data, sensor data output by one or more sensors that detect a state of a device that is an abnormality detection target to detect an abnormality of the device based on the input data, the machine learning model management method comprising:
managing model identifiers that specify the machine learning models and are unique to the machine learning models and sensor identifiers that specify the sensors that output the sensor data serving as the input data of the machine learning models and are unique to the sensors in association with each other;
obtaining, for each maintenance event identifier that specifies a maintenance operation performed on the device and is unique to the maintenance operation, a degree of influence indicating a change in tendency of the sensor data before and after the maintenance operation is performed, and managing the degree of influence in association with each of the sensor identifiers; and
when the sensor whose degree of influence satisfies a predetermined condition is influenced by the maintenance operation, presenting the model identifier associated with the sensor identifier of the sensor that satisfies the condition.
